(19) United States
(12) Patent Application Publication
(10) Pub. No.: US 2011/0315630 A1
(43) Pub. Date: Dec. 29, 2011

(54) EXTRACTION CONTAINER, EXTRACTOR, AND EXTRACTION METHOD

(75) Inventors: Hideyuki MORIKAWA, Akiruno-shi (JP); Hideki Muraki, Akiruno-shi (JP)

(73) Assignee: UNIFLOWS CO., LTD., Akiruno-shi (JP)

(21) Appl. No.: 12/838,827

(22) Filed: Jul. 19, 2010

(30) Foreign Application Priority Data
Jun. 29, 2010 (JP) 2010-147481

(51) Int. Cl. B01D 17/05

(52) U.S. Cl. 210/634; 210/117

(57) ABSTRACT

Simplified liquid-solid and liquid-liquid separations after centrifugal extraction are used to extract a target substance from a substance mixture into a solvent. An extraction container has a closed-end cylindrical shape, and is rotated around a central axis by an extractor rotor driven by a motor. The extraction container includes: an opening provided in a bottom portion thereof; and a valve (valve ball) provided at the opening, and opened or closed by a pressure difference between above and below the valve. In extraction, a substance mixture and a solvent are put into the extraction container. The extraction container is repeatedly subjected to normal rotation, pausing, reverse rotation, and pausing to thereby extract a target substance from the substance mixture into the solvent and to separate the liquids into upper and lower layers. Then, an air pressure hose nozzle is connected to an opening in an upper portion of the extraction container, and an inside of the extraction container is pressurized to open the valve at the bottom portion. Thus, the liquids are sequentially discharged from the liquid in the lower layer.

### CROSS-REFERENCE TO RELATED APPLICATION

This application claims priority from Japanese Patent Application No. 2010-147481 filed on Jun. 29, 2010, the content of which is incorporated herein by reference in its entirety.

### TECHNICAL FIELD

The present invention relates to an extraction container for extracting a target substance from a substance mixture into a solvent by liquid-liquid partitioning or liquid-solid partitioning. The present invention also relates to an extractor and an extraction method which use the extraction container.

### BACKGROUND ART

It has been a common practice for a target component to be obtained from a biological sample (blood, urine, organ, or the like) for medical analysis and analyzed with an analyzer for disease diagnosis or health condition inspection. Means for extracting such a target substance from a substance mixture uses a liquid (solvent) having an affinity with the target substance, and includes the following procedure. Specifically, the substance mixture and the solvent are put into a container and stirred by shaking the container. Thus, the target substance is dissolved into the solvent, which is then left standing or placed in a centrifuge and separated utilizing the difference in specific gravity. Accordingly, the solvent portion is obtained. Thereafter, the solvent is evaporated by heating, depressurizing, or blowing with a gas. In this manner, the target substance is extracted.

For such an extraction operation, various extraction containers and extractors are proposed. For example, extraction containers described in Patent References 1 and 2 are closed-end cylindrical containers. The closed-end cylindrical containers each include an internal tube and perform complicated extraction operations to extract only a lower layer liquid.

### CITATION LIST

[Patent Reference 1]
Japanese Patent Application Publication No. Hei 09-285740

[Patent Reference 2]
Japanese Patent Application Publication No. 2000-157891

### SUMMARY OF INVENTION

### Technical Problem

Various extraction containers have been proposed as an extraction container for the extraction operation, in addition to Patent References 1 and 2 above. Extraction of a biological sample, for example, generally employs shaking extraction, and thus requires centrifugation, extract fractioning, and microfiltration after extraction. Since complex operations are needed as described above, such an extraction scheme has problems in terms of safety from disease infection, extraction efficiency, operation time, operability, possibilities of automation and unattended operation, and so forth.

In view of such circumstances, an object of the present invention is to provide an extraction container particularly suitable for liquid separation after centrifugal extraction, and to provide an extractor and an extraction method which use the extraction container.

### Solution to Problem

To achieve the above object, an extraction container according to the present invention is an extraction container having a closed-end cylindrical shape and configured to extract a target substance from a substance mixture into a solvent by rotating around a central axis with the substance mixture and the solvent contained therein. The extraction container has a characteristic structure including: a lid or a gate provided on an upper portion of the extraction container, the gate extending in an inner diameter direction; an opening provided in a bottom portion of the extraction container; and a valve provided at the opening, and configured to be opened and closed by a pressure difference between above and below the valve.

After the extraction and separation, the valve is opened by pressurizing the inside of the extraction container to relatively high pressure (by pressurizing the inside of the container from the upper portion, or by depressurizing from the bottom portion thereof (i.e., by suction with a pump or a syringe)). Thus, the liquids are sequentially discharged from the liquid in a lower layer.

Moreover, the extraction container preferably includes a connection port for a pressure hose nozzle in the upper portion of the container. Accordingly, the pressurizing of the inside of the container to relatively high pressure is easily performed, that is, the liquids are easily discharged by the opening operation of the valve.

Moreover, the extraction container preferably includes a functional filter at the outlet side of the valve at the opening. The functional filter preferably has a property of separating hydrophobic liquid, hydrophilic liquid, and solid matter from one another, depending on a pressure difference between above and below the functional filter. Accordingly, the separation of the hydrophobic liquid, the hydrophilic liquid, and the solid matter from one another is simplified. Furthermore, the solid matter can be dissolved and collected by adding a dissolving solution (for example, an alkali solution for a protein).

An extractor according to the present invention includes: the above-described extraction container; an extractor rotor having a closed-end cylindrical shape and concentrically holding the extraction container; and a motor disposed below the rotor to drive and rotate the rotor.

Thus, the extraction container is easily mounted. Even a sample which is likely to be emulsified is efficiently extracted without emulsion.

The extractor according to the present invention preferably further includes a pressure hose nozzle connected to an opening in the upper portion of the extraction container to pressurize the inside of the extraction container. Accordingly, the pressurizing of the inside of the container to relatively high pressure is easily performed, that is, the liquids are easily discharged by the opening operation of the valve.

The extractor according to the present invention preferably further includes: a pipe connected to the opening in the bottom portion of the extraction container, the pipe penetrating a bottom portion of the rotor and passing through a hollow rotation shaft of the motor; and a receiving container disposed below an opening in a lower end of the pipe. Instead of collecting a liquid after the extraction container is taken out from the extractor after the extraction and separation, the liquid is collected with the extraction container being attached to the extractor; thus, the operations are simplified, and the automation of the extraction scheme is also more easily achieved. The extractor is particularly effective in the following case in which the extraction container is not replaced. Specifically, the extraction container is washed with a washing liquid put therein after the extraction, and is reused after the liquid is discharged.

An extraction method according to the present invention uses the above-described extraction container, and includes: putting a substance mixture and a solvent into the extraction container; repeatedly subjecting the extraction container to normal rotation, pausing, reverse rotation, and pausing to thereby extract a target substance from the substance mixture into the solvent and to separate the resultant liquids into upper and lower layers; and thereafter pressurizing the inside of the extraction container to relatively high pressure, and thereby opening a valve at a bottom portion of the extraction container to sequentially discharge the liquids from the liquid in the lower layer.

Moreover, in the extraction method according to the present invention, when the inside of the extraction container is pressurized to relatively high pressure, a pressure hose nozzle is connected to an opening in an upper portion of the extraction container. Accordingly, the pressurizing of the inside of the container to relatively high pressure is easily performed, that is, the liquids are easily discharged by the opening operation of the valve.

Moreover, in the extractor and the extraction method according to the present invention, a mixer cutter is inserted through the opening of the extraction container to stir or crush a substance mixture. Specifically, suppose a case in which a substance mixture is separated into two phases and a solvent is unlikely to come into contact with one of the phases (for example, when the substance mixture is a water-oil mixture and the solvent is chloroform, chloroform, water, and oil are settled sequentially in this order from the outer side), or in which a substance mixture contains a solid matter. In such cases, the extraction can be efficiently performed in a short period of time by placing, when the extractor rotor is paused, the mixer cutter in the extraction container to stir or crush the substance mixture, and then performing centrifugal extraction.

### Advantageous Effects of Invention

According to the present invention, liquids separated into upper and lower layers by centrifugal extraction in the extraction container are sequentially discharged by creating a pressure difference between above and below the valve at the bottom portion. The discharging of the liquids is thus simplified. Therefore, in biological sample extraction, the prevent invention can achieve improvement in safety from disease infection, improvement in extraction efficiency, shortening of operation time (improvement in operability), improvement in possibilities of automation and unattended operation, and so forth.

Note that, in medical analysis, dedicated automatic analysis apparatuses are frequently used. Moreover, along with development in medical technologies, higher levels of analyses are required. Accordingly, mass spectrometers (MS), nuclear magnetic resonance (NMR) apparatuses, and the like are put into consideration therefor. However, to widely adopt these apparatuses as medical analysis apparatuses, automatic pretreatments of samples are essential. The present invention is intended to contribute the requirements.

### BRIEF DESCRIPTION OF DRAWINGS

FIG. 1 is a front view of an entire extractor according to one embodiment of the present invention.

FIG. 2 is a side view of the entire extractor according to the same embodiment.

FIG. 3 is vertical cross-sectional view showing a principal part of the extractor according to the same embodiment.

FIG. 4 is a cross-sectional view taken along a line indicated by arrows X-X in FIG. 3.

FIG. 5 is a view illustrating a state of a liquid layer in the container during centrifugal extraction.

FIG. 6 is a view illustrating a state of the liquid layer in the container when the container is left standing.

FIG. 7 is a vertical cross-sectional view showing the principal part when a mixer cutter is provided.

### DESCRIPTION OF EMBODIMENTS

Hereinafter, embodiments of the present invention will be specifically described with reference to the drawings.

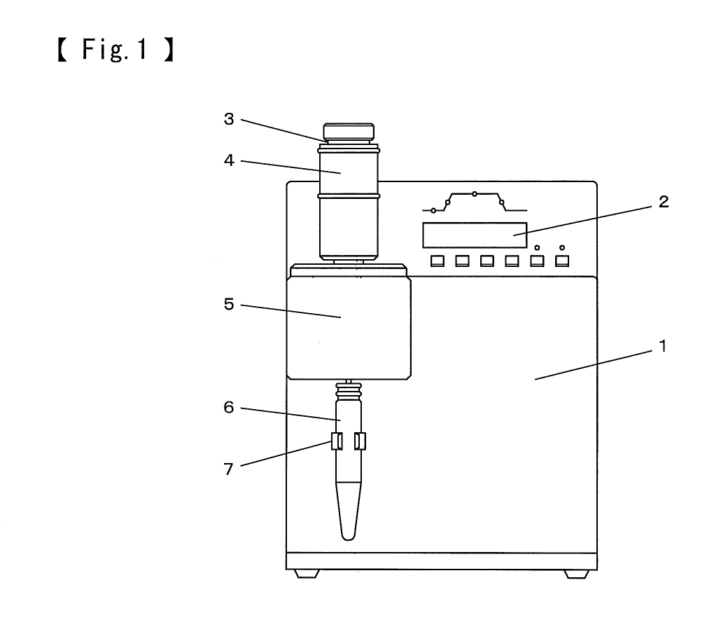

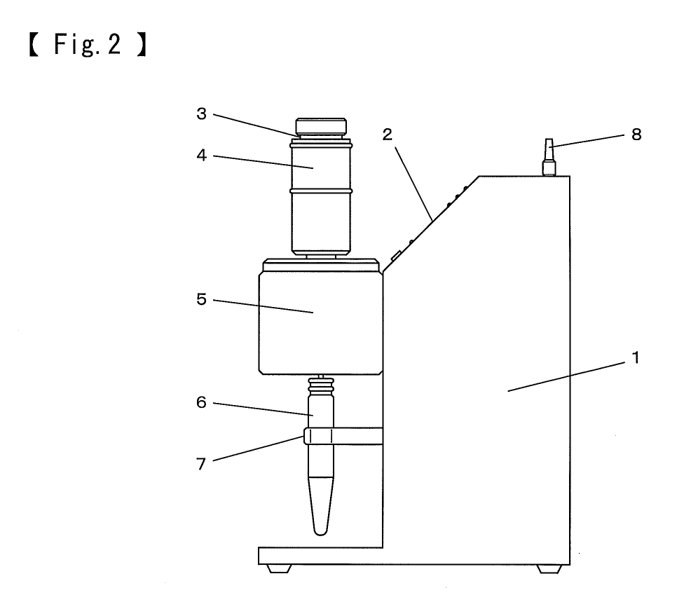

FIG. 1 is a front view of an entire extractor according to one embodiment of the present invention. FIG. 2 is a side view thereof.

The extractor of this embodiment includes, as shown in FIGS. 1 and 2, an extractor body 1, a control display-operation section 2, an extraction container 3, an extractor rotor 4, an extractor rotor-driving unit 5, an extract receiving container 6, an extract receiving container-attachment clip 7, and an air pressure hose nozzle 8.

The control display-operation section 2 is provided on an upper front surface of the extractor body 1, and includes a lamp and a digital display for control display, as well as buttons for control operations including various settings.

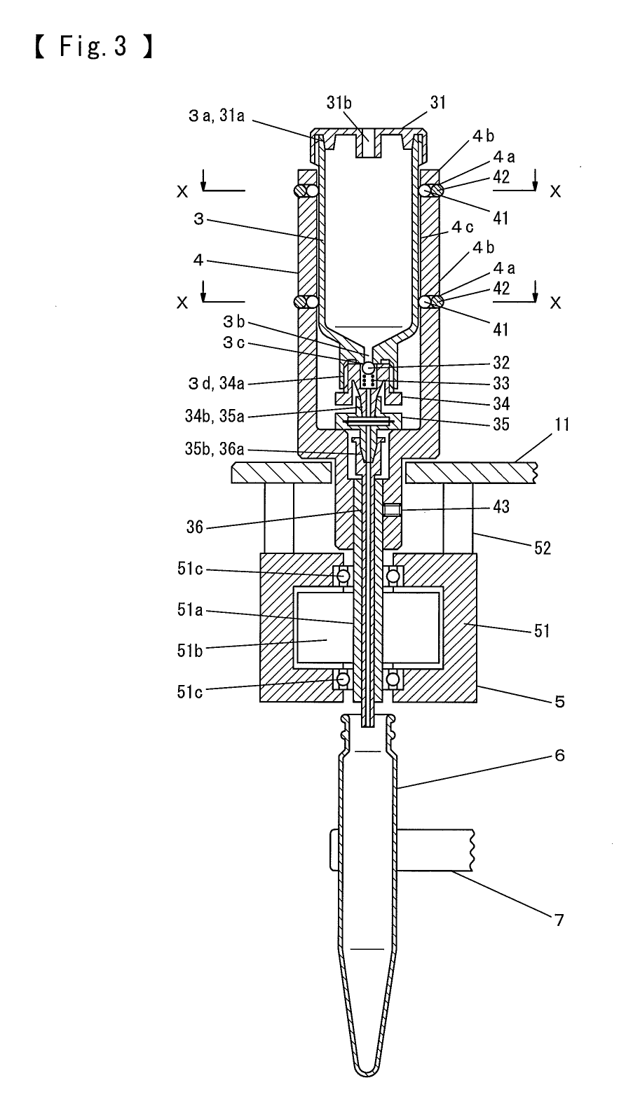

The extraction container 3 is detachably set in the extractor rotor 4. The extractor rotor 4 is driven by the extractor rotor-driving unit 5 and thereby rotates together with the extraction container 3. The extractor rotor-driving unit 5 is mainly constituted of a motor, and is supported to the extractor body 1. The extract receiving container 6 is detachably set to the extract receiving container-attachment clip 7, and it is situated below the extractor rotor-driving unit 5. The extract receiving container-attachment clip 7 sticks out from the extractor body 1, and thus. These components will be described in detail later with FIG. 3.

The air pressure hose nozzle 8 is provided at an upper portion of the extractor body 1, while connected to an air source in the extractor body 1, in a manner that the nozzle 8 can be pulled out from the extractor body 1. After extraction is completed, the nozzle 8 is pulled out and connected to the extraction container 3, and it is used for discharging an extract into the extract receiving container 6 by pressurizing the inside of the extraction container 3. Here, the pressure of the pressurized air is changeable at multiple levels.

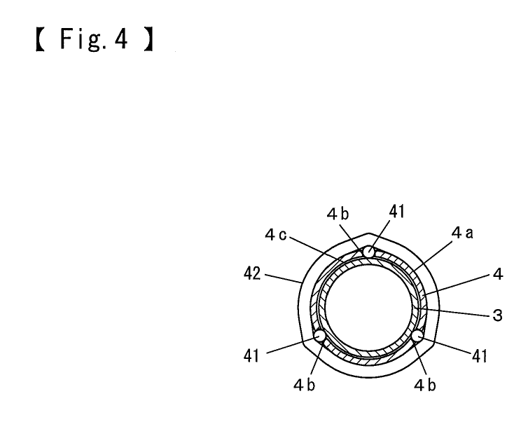

FIG. 3 is a vertical cross-sectional view showing a principal part of the extractor in a state in which the extraction container 3 and the extract receiving container 6 are set thereto. FIG. 4 is a cross-sectional view taken along any one of two lines indicated by arrows X-X in FIG. 3.

A driving motor 51 constituting the extractor rotor-driving unit 5 is supported at a motor attachment panel 11 with an anti-vibration rubber 52 in between. A rotation shaft 51a of the driving motor 51 is rotated upon receipt of a rotational force from a rotor 51b attached to the shaft 51a, and is rotatably supported by bearings 51c, 51c. The shaft 51a is perpendicularly disposed in the driving motor 51, and the inside of the shaft 51a is hollow.

The extractor rotor 4 is shaped to have two cylindrical portions: an upper side having a large diameter and a lower side having a small diameter. The extraction container 3 is mounted in the upper side-cylindrical portion. The lower side-cylindrical portion of the extractor rotor 4 is fitted onto an outer peripheral portion of the rotation shaft 51a of the driving motor 51, and it is fixed thereto with a set screw 43. Thus, the extractor rotor 4 rotates together with rotation shaft 51a of the driving motor 51.

The extraction container 3 has a closed-end cylindrical shape, and is inserted in the upper side-cylindrical portion of the extractor rotor 4.

Annular grooves 4a, 4a each having a U-shaped cross section are formed respectively at upper and lower portions of the outer periphery of the upper side-cylindrical portion of the extractor rotor 4 in which the extraction container 3 is inserted. Ball guide holes 4b are formed in each of the annular grooves 4a at three positions which equally divide the circumference of the annular groove 4a into three. Each of the holes 4b extends from a bottom portion of the groove to an inner peripheral portion thereof. Balls 41 are placed in the ball guide holes 4b, and rubber bands 42 are wound around the annular grooves 4a, whereby the rubber bands 42 push the balls 41 in such a manner that heads of the balls 41 can be seen bulging from an inner wall 4c of the extractor rotor 4.

Thus, the extraction container 3 inserted in the upper side-cylindrical portion of the extractor rotor 4 is concentrically held to the extractor rotor 4 by the force of the rubber bands 42 with the balls 41 in between. The extraction container 3 is capable of rotating together with the extractor rotor 4.

The extraction container 3 has a closed-end cylindrical shape, and includes an opening in an upper portion thereof. A container lid 31 is provided on the opening. The container lid 31 is hermetically fittable onto the opening of the extraction container 3 with screws 3a, 31a. Moreover, the container lid 31 includes an opening 31b in a central portion thereof.

The extraction container 3 further includes an opening 3b formed in the center of a bottom portion of the container 3. A lower end 3c thereof serves as a hermetic valve seat for a valve ball 32 constituting a valve. The valve ball 32 is biased upwardly, i.e., in a direction in which the valve is closed, with a compression spring 33 that works on the valve ball 32. When the difference in pressure applied above and below the valve ball 32 becomes a predetermined value or greater, the valve ball 32 moves downward to open the valve. The predetermined value (the pressure difference when the valve is opened) should be set from 10 to 20 KPa at which the valve is not opened by the weights of a sample and an extract put in the extraction container 3. The valve ball 32 and the compression spring 33 are held by a valve holder 34. The valve holder 34 is fixed to the bottom portion of the extraction container 3 with screws 3d, 34a.

A functional filter 35 is disposed on a bottom portion of the upper side-cylindrical portion of the extractor rotor 4, and located below the valve holder 34. The valve holder 34 is hermetically connected to the functional filter 35 with fitting parts 34b, 35a.

Moreover, a pipe 36 is disposed in the lower side-cylindrical portion of the extractor rotor 4, and it is located below the functional filter 35. The functional filter 35 is hermetically connected to the pipe 36 with fitting parts 35b, 36a.

Thus, a path in the valve holder 34 downstream of the valve ball 32 is connected to a path in the pipe 36 through the functional filter 35.

The pipe 36 is pulled into the hollow rotation shaft 51a of the driving motor 51. A lower end portion of the pipe 36 projects out from a lower end portion of the hollow rotation shaft 51a.

The extract receiving container 6 has a closed-end cylindrical shape, and is attached to the extract receiving container-attachment clip 7 in such a manner that the lower end portion of the pipe 36 is accommodated into an opening of an upper portion of the extract receiving container 6.

Next, an extraction method will be described in which a target substance is extracted from a substance mixture into an extraction solvent using the above-described extractor. The description will be given exemplifying a case in which a component in a sample (for example, blood) is extracted with an extract (chloroform).

The following settings are made with the control display-operation section 2: rotor rotation starting-up period, high-speed rotating period, rotation starting-down period, pausing time, and the number of repetitions. Generally, the starting-up period is set 5 seconds, the high-speed rotating period is set 5 seconds, the starting-down period is set 5 seconds, the pausing time is set 5 seconds, and the number of repetitions is set 5. Depending on samples or extracts, these setting values are altered.

Next, an extract (chloroform) and a sample (blood) are put into the extraction container 3 through the opening 31b in the container lid 31. Next, the extraction start button on the control display-operation section 2 is pushed to start the extraction.

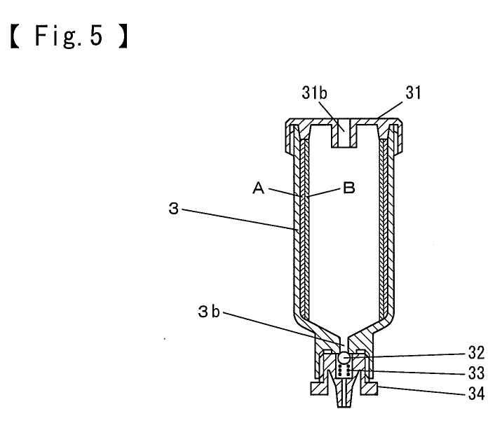

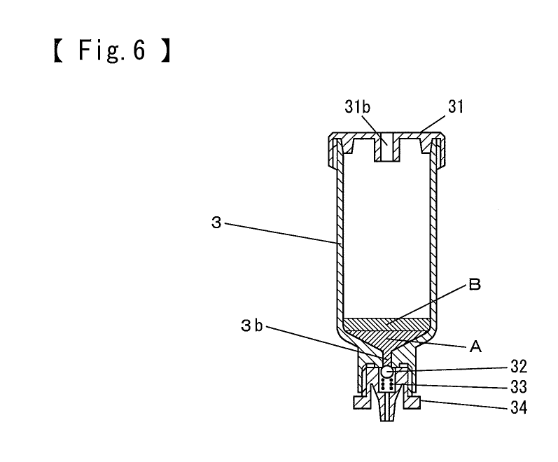

Refer to FIGS. 5 and 6. When the rotation of the extraction container 3 together with the extractor rotor 4 is started, an extract (chloroform) A and a sample (blood) B in the extraction container 3 are in a state as shown in FIG. 5. Meanwhile, when the rotation is stopped, the extract A and the sample B are in a state as shown in FIG. 6. Next, while the rotation direction is being changed, the rotating and pausing are repeated by the number of repetitions having been set. In the end, the rotation is gradually stopped so as not to mix the two liquids. The states of both liquids A, B are as follows. When the rotation of the extractor rotor 4 starts up, the extraction container 3 rotates the fastest, the liquid A the second fastest, and the liquid B the third fastest. When the rotation slows down, the liquid B rotates the fastest, the liquid A the second fastest, and the extraction container 3 the third fastest. Accordingly, the liquids slip on each other at the interface therebetween, and the extraction can be made quickly by separating the liquids from each other. Furthermore, the rotation stops and the liquids are then rotated while newly coming into contact with each other at contact surfaces changed from those in the previous rotation. Thereby, the extraction can be performed in a short period of time. In addition, emulsion is prevented by performing centrifugation and gradually stopping the centrifugation in the end so as not to mix the two liquids.

In the state of FIG. 6 after the extraction, the air pressure hose nozzle 8 is pulled out and hermetically connected to the opening 31b in the container lid 31. Then, a pressure high enough to overwhelm the compression spring 33 is applied. Thereby, the valve ball 32 is moved downward to open the valve, and the extract A on the lower layer side is first discharged.

The discharged extract A enters the functional filter 35. When a hydrophobic filter is used as the functional filter 35, the extract A passes through the filter 35, and then through the pipe 36, and enters the extract receiving container 6. The sample B cannot pass through the functional filter 35 because of the properties of the filter 35. Thus, the extract receiving container 6 receives only the extract A.

Next, the extract receiving container 6 is replaced, and a pressure high enough to overcome the properties of the functional filter 35 is applied from the air pressure hose nozzle 8 through the opening 31b. Thereby, the sample B passes through the filter 35, and then through the pipe 36, and enters the extract receiving container 6. Thus, the sample B can also be collected.

Furthermore, when a solid matter such as a protein remains in the container 3, the extract receiving container 6 is replaced, and an alkaline solution is put into the container 3 through the opening 31b to dissolve the solid matter. Thereby, such solid matter can also be collected in the extract receiving container 6.

When another sample is extracted, the extraction unit can be easily replaced by a manipulator (not illustrated). In addition, when washed and used again, the extraction unit can be easily washed after a washing solution is put through the opening 31b.

In this embodiment, the extraction container 3 includes: the opening 3b provided in the bottom portion thereof; and the valve (valve ball 32) provided at the opening 3b, the valve being configured to be opened and closed by a pressure difference between above and below the valve. Accordingly, after the extraction and separation, the valve (valve ball 32) is opened by pressurizing the inside of the extraction container 3 to relatively high pressure. Thus, the liquids are discharged sequentially from a liquid on the lower layer side.

Here, the pressurizing of the inside of the extraction container 3 to relatively high pressure may be performed by depressurizing from the bottom portion thereof, i.e., by suction with a pump or a syringe. Nevertheless, when the inside of the container is pressurized from the upper portion, such pressurizing is achieved more easily. Specifically, the pressurizing is more easily achieved with the structure including: a connection port (31b) for pressure hose nozzle provided in the upper portion of the extraction container 3; and the pressure hose nozzle 8 connected to the connection port (31b).

Moreover, the extraction container 3 includes the functional filter 35 at the outlet side of the valve (valve ball 32) at the opening 3b in the bottom portion of the extraction container 3. The separation of hydrophobic liquid, hydrophilic liquid, and solid matter from one another is further simplified when the functional filter 35 is a hydrophobic filter and has a property of separating these matters depending on a pressure difference between above and below the functional filter.

Incidentally, the functional filter 35 does not have to be a hydrophobic filter, and a hydrophilic filter may be used depending on the combination of a sample and an extract.

Furthermore, the extractor of this embodiment includes: the above-described extraction container 3; the extractor rotor 4 having a closed-end cylindrical shape and concentrically holding the extraction container 3; the motor 51 disposed below the rotor 4 to drive and rotate the rotor 4; the pipe 36 connected to the opening 3b in the bottom portion of the extraction container 3, the pipe 36 penetrating the bottom portion of the rotor 4 and passing through the hollow rotation shaft 51a of the motor 51; and the receiving container 6 disposed below an opening in the lower end of the pipe 36. Accordingly, an extract and a sample after the extraction and separation are received in a considerably simplified manner.

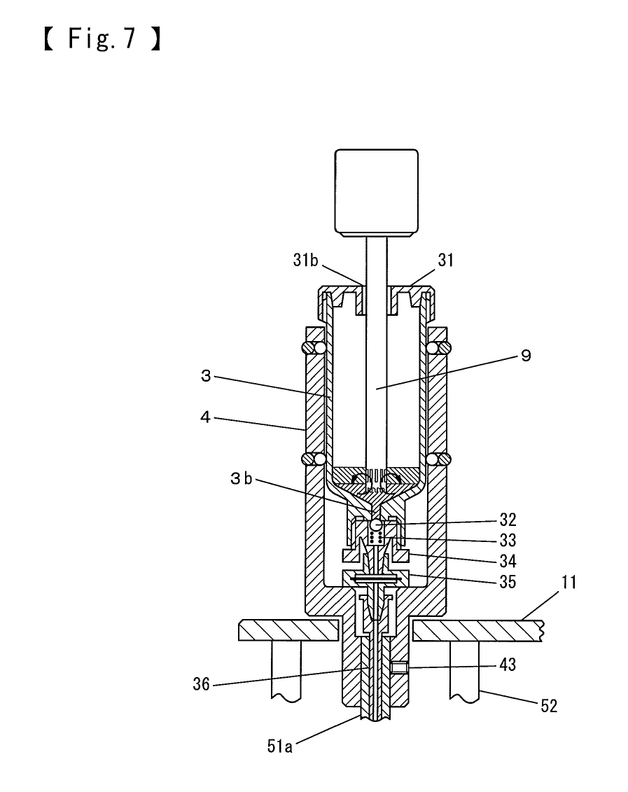

FIG. 7 shows another embodiment of the present invention.

When a sample is a water-oil mixture which is separated into two phases during centrifugal extraction as in FIG. 5 or when a sample contains solid matter, a mixer cutter 9 is desirably placed in the container 3 through the opening 31b as shown in FIG. 7 to stir or crush the solid matter when the extractor rotor 4 is paused. The mixer cutter 9 may be of a generally available type in which an outer blade is fixed and an inner blade is rotatable.

Note that, in the above-described embodiments, the container lid 31 including the opening 31b in the central portion thereof is detachably provided on the upper portion of the extraction container 3. Alternatively, a gate extending in an inner diameter direction may be integrally provided in advance around the entire circumference of the opening in the upper portion of the extraction container 3.

Furthermore, the illustrated embodiments merely exemplify the present invention. Thus, of course the present invention includes various improvements and modifications that can be made within the scope of claims by those skilled in the art, in addition to those directly illustrated by the above-described embodiments.

### INDUSTRIAL APPLICABILITY

The present invention enables automatic pretreatments on samples, and pioneers a way to widely adopt mass spectrometers (MS), nuclear magnetic resonance (NMR) apparatuses, and the like as medical analysis apparatuses. Moreover, the present invention contributes to general analysis, environmental analysis, and drug development in handling biological samples, also.

### REFERENCE SIGNS LIST

1 EXTRACTOR BODY
2 CONTROL DISPLAY-OPERATION SECTION
3 EXTRACTION CONTAINER
4 EXTRACTOR ROTOR
5 EXTRACTOR ROTOR-DRIVING UNIT
6 EXTRACT RECEIVING CONTAINER
7 EXTRACT RECEIVING CONTAINER-ATTACHMENT CLIP
8 AIR PRESSURE HOSE NOZZLE
9 MIXER CUTTER
11 MOTOR ATTACHMENT PANEL
31 CONTAINER LID
32 VALVE BALL
33 COMPRESSION SPRING
34 VALVE HOLDER
35 FUNCTIONAL FILTER
36 PIPE
41 BALL
42 RUBBER BAND
51 MOTOR
52 ANTI-VIBRATION RUBBER

1. An extraction container having a closed-end cylindrical shape and configured to extract a target substance from a substance mixture into a solvent by rotating around a central axis with the substance mixture and the solvent contained therein, the extraction container comprising:
any one of a lid and a gate provided on an upper portion of the extraction container, the gate extending in an inner diameter direction;
an opening provided in a bottom portion of the extraction container; and
a valve provided at the opening, and configured to be opened and closed by a pressure difference between above and below the valve.

2. The extraction container according to claim 1, further comprising a functional filter at an outlet side of the valve at the opening, wherein the functional filter has a property of separating hydrophobic liquid, hydrophilic liquid, and solid matter from one another depending on a pressure difference between above and below the functional filter.

3. An extractor comprising:
the extraction container according to claim 1;
an extractor rotor having a closed-end cylindrical shape and concentrically holding the extraction container; and
a motor disposed below the rotor to drive and rotate the rotor.

4. The extractor according to claim 3, further comprising a pressure hose nozzle connected to an opening in the upper portion of the extraction container to pressurize an inside of the extraction container.

5. The extractor according to claim 3, further comprising:
a pipe connected to the opening in the bottom portion of the extraction container, the pipe penetrating a bottom portion of the rotor and passing through a hollow rotation shaft of the motor; and
a receiving container disposed below an opening in a lower end of the pipe.

6. The extractor according to claim 3, further comprising a mixer cutter inserted through the opening in the upper portion of the extraction container to stir or crush the substance mixture.

7. An extraction method which uses the extraction container according to claim 1, comprising:
placing a substance mixture and a solvent into the extraction container;
repeatedly subjecting the extraction container to normal rotation, pausing, reverse rotation, and pausing to thereby extract a target substance from the substance mixture into the solvent and to separate the resultant liquids into upper and lower layers; and
thereafter pressurizing an inside of the extraction container to relatively high pressure, thereby opening a valve at a bottom portion of the extraction container to sequentially discharge the liquids from the liquid in the lower layer.

8. The extraction method according to claim 7, wherein when the inside of the extraction container is pressurized to relatively high pressure, a pressure hose nozzle is connected to an opening in an upper portion of the extraction container.

9. The extraction method according to claim 7, wherein before the extraction, a mixer cutter is inserted through the opening in the upper portion of the extraction container to stir or crush the substance mixture.

10. An extractor comprising:
the extraction container according to claim 2;
an extractor rotor having a closed-end cylindrical shape and concentrically holding the extraction container; and
a motor disposed below the rotor to drive and rotate the rotor.

11. The extractor according to claim 4, further comprising:
a pipe connected to the opening in the bottom portion of the extraction container, the pipe penetrating a bottom portion of the rotor and passing through a hollow rotation shaft of the motor; and
a receiving container disposed below an opening in a lower end of the pipe.

12. The extractor according to claim 4, further comprising a mixer cutter inserted through the opening in the upper portion of the extraction container to stir or crush the substance mixture.

13. The extractor according to claim 5, further comprising a mixer cutter inserted through the opening in the upper portion of the extraction container to stir or crush the substance mixture.

14. An extraction method which uses the extraction container according to claim 2, comprising:
placing a substance mixture and a solvent into the extraction container;
repeatedly subjecting the extraction container to normal rotation, pausing, reverse rotation, and pausing to thereby extract a target substance from the substance mixture into the solvent and to separate the resultant liquids into upper and lower layers; and
thereafter pressurizing an inside of the extraction container to relatively high pressure, thereby opening a valve at a bottom portion of the extraction container to sequentially discharge the liquids from the liquid in the lower layer.

15. The extraction method according to claim 8, wherein before the extraction, a mixer cutter is inserted through the opening in the upper portion of the extraction container to stir or crush the substance mixture.
